(19) United States
(12) Patent Application Publication
(10) Pub. No.: US 2025/0233956 A1
(43) Pub. Date: Jul. 17, 2025

(54) PRINTER

(71) Applicant: BROTHER KOGYO KABUSHIKI KAISHA, Nagoya (JP)

(72) Inventor: Rui NAKAYAMA, Gifu (JP)

(73) Assignee: BROTHER KOGYO KABUSHIKI KAISHA, Nagoya (JP)

(21) Appl. No.: 19/019,943

(22) Filed: Jan. 14, 2025

(30) Foreign Application Priority Data
Jan. 15, 2024 (JP) 2024-004134

(51) Int. Cl. H04N 1/23; H04N 1/00

(52) U.S. Cl. CPC H04N 1/2323; H04N 1/00915

(57) ABSTRACT

A printer comprises a sheet tray configured to accommodate a sheet of an A5 size in a first orientation corresponding to a horizontal feed conveyance, and a controller. The controller is configured to receive a print job from an IPP client, and perform printing based on the received print job. In a case where the AS size is set as a sheet size and a particular sheet tray is not designated as a sheet feed tray in the print job received from the IPP client, the controller is configured to start the horizontal feed conveyance of the sheet of the A5 size set in the sheet tray in the first orientation, and perform printing, based on the print job, on the sheet conveyed from the sheet tray with using print setting for a landscape A5 size printing.

### REFERENCE TO RELATED APPLICATIONS

This application claims priority from Japanese Patent Application No. 2024-004134 filed on Jan. 15, 2024. The entire content of the priority application is incorporated herein by reference.

### BACKGROUND ART

The present disclosure relates to a printer configured to perform printing in accordance with the IPP (Internet Printing Protocol) standard.

In recent years, it has become possible to control printers in accordance with the IPP (Internet Printing Protocol) standard, both through application programs installed on information processing devices and through cloud-based printing services. In a driverless printing technology that conforms to the IPP standard, printing jobs are generated according to the specified content by accepting sheet size and other settings in accordance with the IPP standard, without using the printer driver provided by the printer vendor.

### SUMMARY

In the case of the IPP standard, there is no definition of a standard size for landscape orientation. For this reason, IPP clients that generate print jobs in accordance with the IPP standard will not generate print jobs with such sheet sizes as specified. On the other hand, there are printers that can handle standard sizes for landscape orientation. Therefore, there is room for improvement in terms of enabling printers to print based on print jobs in accordance with the IPP standard.

According to aspects of the present disclosures, a printer includes a sheet tray configured to accommodate a sheet of an A5 size in a first orientation, the first orientation corresponding to a horizontal feed conveyance in which long sides of the sheet of the A5 size are positioned at leading and trailing ends in a conveying direction, and a controller. The controller is configured to receive a print job from an IPP client configured to generate the print job in accordance with an IPP standard, and perform printing based on the received print job. In a case where the A5 size is set as a sheet size and a particular sheet tray is not designated as a sheet feed tray in the print job received from the IPP client, the controller is configured to start the horizontal feed conveyance of the sheet of the A5 size set in the sheet tray in the first orientation, and perform printing, based on the print job, on the sheet conveyed from the sheet tray with using print setting for a landscape A5 size printing.

Further, according to aspects of the present disclosures, a printer includes a tray supporting horizontal feeding which is a sheet tray configured to accommodate a sheet of a particular size in a first orientation, the first orientation corresponding to a horizontal feed conveyance in which long sides of the sheet of the A5 size are positioned at leading and trailing ends in a conveying direction, and a controller. The controller is configured to receive a print job from an IPP client configured to generate the print job in accordance with an IPP standard, and perform printing based on the received print job. In a case where the particular size is set as a sheet size and a particular sheet tray is not designated as a sheet feed tray in the print job received from the IPP client, the controller is configured to start the horizontal feed conveyance of the sheet of the particular size set in the tray supporting horizontal feeding in the first orientation, and perform printing, based on the print job, on the sheet conveyed from the tray supporting horizontal feeding with using print setting for a landscape printing of a sheet of the particular size.

### BRIEF DESCRIPTION OF DRAWINGS

FIG. 1 is a block diagram of a printer according to an embodiment of the present disclosure.

FIGS. 2A and 2B are explanatory diagrams showing sheets contained in a sheet feed tray.

FIGS. 3A, 3B and 3C show examples of tray information.

FIG. 4 is a flowchart illustrating an IPP printing process.

FIG. 5 is a flowchart illustrating a tray selecting process.

FIG. 6 is a flowchart illustrating a driver printing process.

FIG. 7 is an explanatory diagram illustrating example of print settings.

FIGS. 8A, 8B and 8C are explanatory diagrams illustrating examples of print results.

### DESCRIPTION

Hereinafter, an embodiment of a printer according to aspects of the present disclosure will be described with reference to the accompanying drawings. A printer according to the present embodiment is a printer that is configured to perform printing based on a print job generated in accordance with the IPP (Internet Printing Protocol) standard.

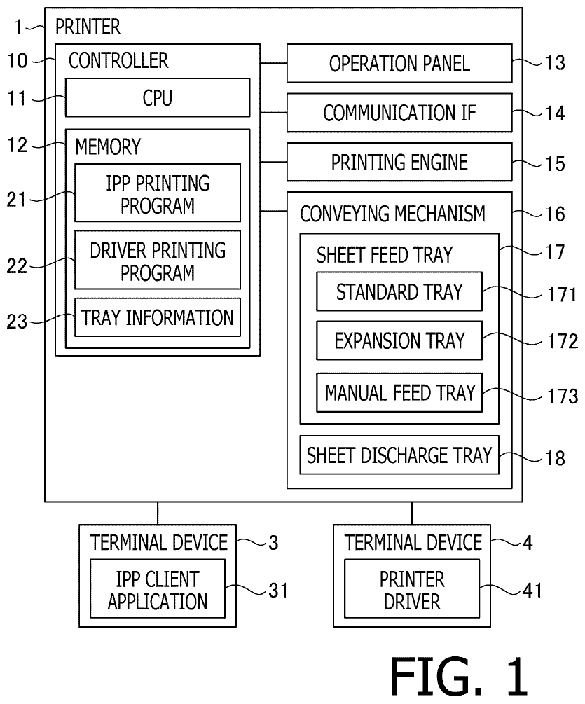

As shown in FIG. 1, a printer 1 according to the present embodiment includes a controller 10 including a CPU 11 and a memory 12. Further, the printer 1 includes an operation panel 13, a communication interface (hereinafter referred to as a “communication IF”) 14, a printing engine 15, and a conveying mechanism 16, which are electrically connected to the controller 10.

The CPU 11 executes various processes according to programs read from the memory 12 and based on user operations. The controller 10 in FIG. 1 is a generic term that refers to hardware and software used to control the printer 1, and does not necessarily refer to a single piece of hardware that actually exists in the printer 1. The CPU 11 may be an example of a controller.

In the memory 12 of the printer 1 of the present embodiment, various programs and various data are stored, including an IPP printing program 21, a driver printing program 22, and tray information 23. Details of each program and data will be described later. The memory 12 is also used as a work area when various processes are executed.

It should be noted that an example of the memory 12 may be a ROM, a RAM, an HDD, and the like built into the printer 1, but not limited to these, but may also be a storage medium that can be read and written by the CPU 11. For example, an external memory such as a USB memory stick or an HDD connected to the printer 1 via a communication interface 14, or a memory or an HDD provided in a device connected to the printer 1 via a communication interface 14, is also an example of the memory 12. The buffer provided in the CPU 11 is also an example of the memory 12.

The computer-readable storage medium are a non-transitory medium. In addition to the examples given above, the non-transitory medium also includes a storage medium such as CD-ROMs and DVD-ROMs. In addition, the non-transitory medium is also a tangible medium. On the other hand, the electrical signals that carry programs downloaded from servers on the Internet, and the like, are one type of the computer-readable medium, i.e., a computer-readable signal medium, but they are not included in the non-transitory computer-readable storage medium.

The operation panel 13 includes hardware configured to display a screen to notify a user of information and hardware configured to accept a user operation. The operation panel 13 may include a touch panel having a notification function and an operation receiving function. The operation panel 13 may include an indicator lamp, various buttons, and a numeric keypad.

The communication IF 14 includes hardware for communicating with external devices. The communication standards for the communication IF 14 include Ethernet (a registered trademark of Xerox Corporation), Wi-Fi (a registered trademark of Wi-Fi Alliance), and USB (Universal Serial Bus). The printer 1 may include the multiple communication IFs 14 to support a variety of communication standards.

The printing engine 15 includes a configuration for printing images based on image data on a printing medium such as a sheet. The printing method of the printing engine 15 is, for example, an electrophotographic method or an inkjet method. The printing engine 15 may be configured to perform color printing or monochrome printing.

The conveying mechanism 16 is a mechanism configured to convey a printing medium such as sheets using the printing engine 15. The conveying mechanism 16 includes a sheet feed tray 17 configured to accommodate sheets before printing, a sheet discharge tray 18 configured to accommodate sheets after printing, and a plurality of conveying rollers. The sheet feed tray 17 may be an example of a sheet tray according to aspects of the present disclosure. A plurality of sheet feed trays 17 are detachably attached with the printer 1. Concretely, according to the present embodiment, the printer 1 has a standard tray 171, an expansion tray 172, and a manual feed tray 173, as sheet feed trays 17. The printer 1 may include multiple sheet discharge trays 18.

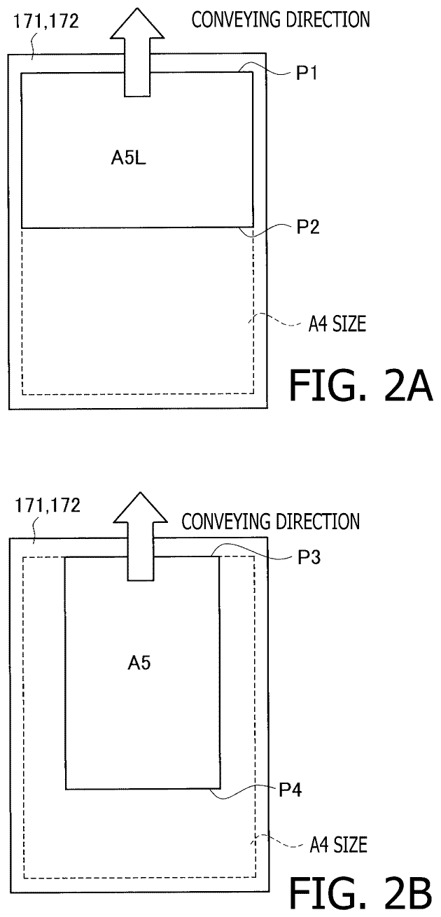

Among the multiple sheet feed trays 17 provided to the printer 1, at least the standard tray 171 and the expansion tray 172 are large enough to accommodate A4 size (210 mm×297 mm) sheets. These trays are configured to hold A4 size sheets in one orientation, concretely, a second orientation as described below, as shown by dashed lines in FIGS. 2A and 2B. A conveying direction when the conveying of sheets from each tray starts is a direction from a lower side to an upper side in FIGS. 2A and 2B. In other words, the printer 1 can convey A4 size sheets with short sides of the sheets at the leading and trailing ends in the conveying direction, and can print A4 size images in the portrait orientation on the conveyed sheets. The manual feed tray 173 is also configured in such manner that A4 size sheets can be set in the second orientation.

Additionally, each sheet feed tray 17 of the printer 1 can hold A5-sized sheets (148 mm×210 mm) in two orientations, i.e., a first orientation shown in FIG. 2A and a second orientation shown in FIG. 2B. A first orientation is an orientation in which the longer side of the sheet is the leading edge P1 and the trailing edge P2 in the conveying direction, and corresponds to a horizontal feed conveyance in which the sheet is conveyed to the printing engine 15 in a horizontal state. A second orientation is an orientation in which the shorter side of the sheet is the leading edge P3 and the trailing edge P4 in the conveying direction, and corresponds to a vertical feed conveyance in which the sheet is conveyed to the printing engine 15 in a vertical state.

The printer 1 is configured to receive sheet size settings for each sheet feed tray 17 installed through the operation panel 13. The printer 1 receives settings for each sheet feed tray 17, including information on the sheet size of sheets that can be set in each sheet feed tray 17 and the orientation of the sheets that are to be set. The printer 1 is configured to accept, as a size setting, not only the sheet sizes defined in the IPP standard (e.g., A5 size) but also sheet sizes not defined in the IPP standard (e.g., A5 size landscape orientation).

A setting size for the A5-sized sheets set in the first orientation shown in FIG. 2A is “A5L,” and a setting size for the A5-sized sheets set in the second orientation shown in FIG. 2B is “A5.” “A5L” represents the size for printing on A5-sized sheets in the landscape orientation and is an example of a first size, while “A5” represents the size for printing on A5-sized sheets in the portrait orientation and is an example of a second size. The tray with the setting size of “A5L” is an example of the first tray, and the tray with the setting size of “A5” is an example of the second tray.

In other words, the printer 1 operates, for example, assuming that A5-sized sheets are set in the first orientation in the sheet feed tray 17 that the setting size is “A5L.” Similarly, the printer 1 operates assuming that A5-sized sheets are set in the second orientation in the sheet feed tray 17 that the setting size is “A5.” Additionally, the printer 1 may have a function to detect the sheet size of the sheets set in each sheet feed tray (17) using multiple sensors. In such a case, the setting size can be determined based on the detection results.

As described above, each sheet feed tray 17 of the printer 1 is configured such that the A4-sized sheets can be set in the second orientation, but cannot be set in the first orientation. When the set size is “A4”, the printer 1 operates assuming that the A4-sized sheets are set in the second orientation. It should be noted that “A4” is a size for portrait A4 size printing and is an example of a third size. The printer is configured so as not to accept the “A4L” setting, which indicates that the A4-sized sheets are set in the first orientation. It should be noted that “A4L” is a size for landscape A4 size printing, and is an example of a fourth size.

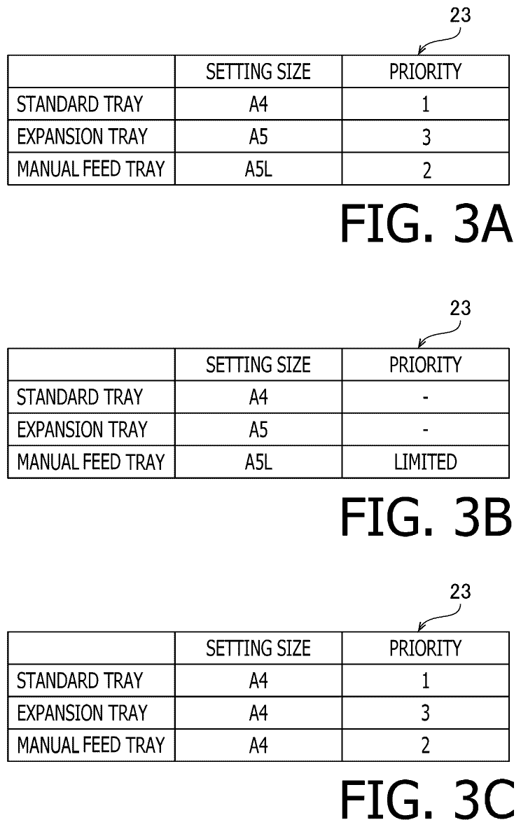

Multiple sheet feed trays 17 are installed to the printer 1, and the printer 1 stores tray information 23, which is information used to determine which sheet feed tray 17 should be used for printing, in memory 12. The tray information 23 includes, for example, information indicating a sheet size set for each sheet feed tray 17 (hereafter, referred to as a “set sheet size”) and priority information indicating the priority of each sheet feed tray 17, as shown in FIGS. 3A-3C.

In FIGS. 3A-3C, the priority information indicates the priority order assuming all sheet feed trays 17 are used. Since the printer 1 has three sheet feed trays 17, each sheet feed tray 17 is assigned a priority number from 1 to 3 as priority information. The printer 1 is configured to accept priority settings via, for example, the operation panel 13. For example, if the priorities are set as shown in FIG. 3A or FIG. 3B, in the printer 1, the standard tray 171 is given the highest priority, the manual feed tray 173 is given next-highest priority, and the expansion tray 172 is given the lowest priority.

In addition, the printer 1 is configured to accept a setting that exclusively designates the trays that are available for use from among all the sheet feed trays 17, as priority information. In such cases, the tray information 23 contains information indicating the trays that are set to be available for use. For example, the tray information 23 shown in FIG. 3B contains information indicating that the manual feed tray 173 among the sheet feed trays 17 is available for use, while the standard tray 171 and the expansion tray 172 are restricted for use (i.e., the manual feed tray 173 is exclusively designated). The sheet feed tray 17, which is set to “exclusive designation” as a priority (i.e., the manual feed tray 173 in the example of FIG. 3B), may be an example of an exclusive designated tray.

The printer 1 according to the present embodiment is configured to communicate with terminal devices 3 and 4 via the communication IF 14 as shown in FIG. 1. Each of the terminal devices 3 and 4 is a device capable of sending a printing job to the printer 1, and is, for example, a smartphone, a tablet terminal, a personal computer, or the like.

The terminal device 3 has an application program 31 configured to execute various processes in accordance with the IPP standard (hereinafter referred to as “IPP client application”). By executing an IPP client application 31, the terminal device 3 can generate a print job (hereinafter referred to as an “IPP job”) in accordance with the IPP standard as an IPP client and transmit the generated IPP job to the printer 1. The terminal device 3 may also have a printer driver corresponding to the printer 1.

The terminal device 4 has a printer driver 41 corresponding to the printer 1. By using the printer driver 41, the terminal device 4 can transmit a print job (hereinafter referred to as a “driver job”) generated by the printer driver 41 to the printer 1. The terminal device 4 may also have an IPP client application.

The range of values that can be set for the parameters contained in the print job may differ between IPP jobs and driver jobs. For example, the values that can be set for the parameter that specifies the sheet size (hereinafter referred to as “size parameter”) among the parameters contained in the print job are different between IPP jobs and driver jobs. Concretely, for driver jobs, both “A5” and “A5L” can be set as the size parameter, while for IPP jobs, “A5” can be set as the size parameter, but “A5L” cannot be set. The printer 1 can execute printing based on print jobs where the size parameter is set as either “A5” or “A5L.”

Hereinafter, an operation of the IPP printing by the printer 1 is described with reference to flowcharts. It should be noted that processes described below basically show the processing of the CPU 11 according to the instructions written in programs. In other words, the processing such as “judgment,” “extraction,” “selection,” “calculation,” “decision,” “identification,” “acquisition,” “obtaining,” and “control” in the following description represent the processing of the CPU 11. The processing by the CPU 11 includes hardware control using an API of the OS.

In this specification, the operation of each program is explained without explicitly using the term “operating system” (OS). Therefore, in the following explanation, statements such as “program B controls hardware C” may be understood as “program B controls hardware C by using the API of the OS.” Additionally, the processing executed by the CPU 11 according to the instructions described in the program may be expressed in an abbreviated form. For example, it may be described as “the CPU performs” or, in some cases, the CPU may be omitted entirely, and the processing may be described as “program A performs,” instead of explicitly mentioning the CPU.

The term “obtaining” is used in a concept that does not require a request. In other words, the concept of “the CPU obtaining data” also includes the process of receiving data without the CPU making a request.

Further, “data” in this specification is expressed as a bit string that can be read by a computer. Data with the same substantive meaning but different formats will be treated as the same data. The same applies to “information” in this specification. In addition, the concepts of “requesting,” and “instructing” refer to the act of outputting information to the other party that indicates that a request is being made or that instructions are being given. The terms “request” and “instruct” are also used to refer to the information that indicates that a request is being made or that instructions are being given.

The process performed by the CPU 11 to determine whether information A indicates an event B may sometimes be conceptually described as “determining from information A whether the event B is true.” Similarly, the process performed by the CPU 11 to determine whether information A indicates either event B or event C may sometimes be conceptually described as “determining from information A whether it indicates Event B or Event C.”

When the printer 1 starts receiving a print job from an external device, the printer 1 determines whether the received print job is an IPP job output by the IPP client application 31 or a driver job output by the printer driver 41. If determining that the received job is the IPP job, the printer 1 executes an IPP printing process based on the IPP printing program 21.

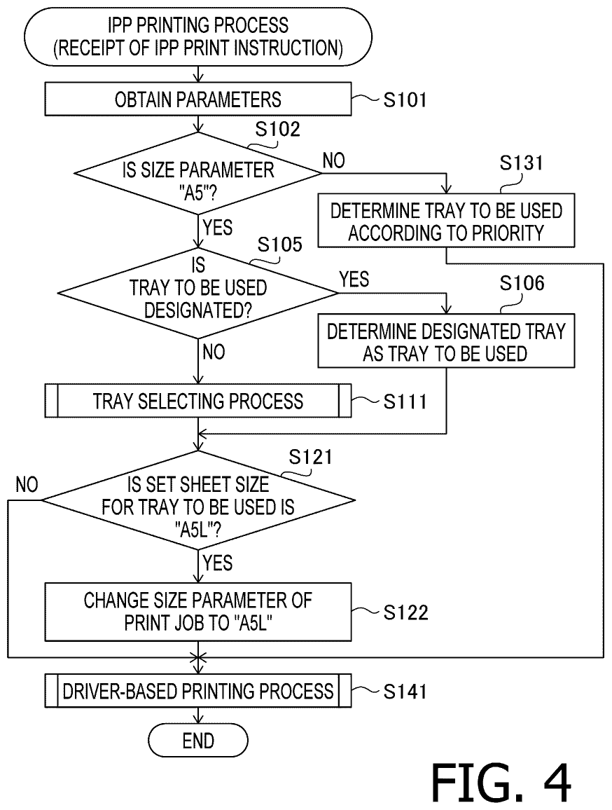

The procedure for the IPP printing process executed by the printer 1 is described with reference to a flowchart shown in FIG. 4. In this specification, the procedure is described under the assumption that the image data included in the print job, which indicates the image to be printed, represents a portrait image.

The CPU 11 first obtains information on the parameters contained in the IPP job that is being received (S101). The CPU 11 then determines whether the size parameter of the IPP job is “A5” (S102). If the size parameter is determined to be “A5” (S102: YES), the CPU 11 determines whether the parameters included in the IPP job specify the use of a particular sheet feed tray (S105).

The IPP job parameters sometimes include a sheet feed tray specifying parameter that designates the sheet feed tray 17 to be used. In the IPP job, it is possible to specify either a specific parameter that concretely sets one of the sheet feed trays 17 that the printer 1 has, or an automatic selection that indicates that the sheet feed tray to be used will be automatically selected by the printer 1. An IPP job with the sheet feed tray parameter set to automatic selection may be an example of a print job in which no specific sheet tray is designated as the sheet feed tray, and also an example of a print job where the automatic selection of the sheet feed tray is designated. It should be noted that there may be IPP jobs that do not include sheet feed tray parameters. The IPP jobs that do not include the sheet feed tray parameters may be an example of a print job that do not specify a particular sheet tray as the sheet feed tray.

If the CPU 11 determines that a particular sheet tray has been designated as the sheet feed tray, i.e. that the sheet feed tray 17 to be used has been designated in the print job (S105: YES), the CPU 11 determines the tray designated in the print job as the tray to be used (S106). The tray that is determined to be the tray to be used is the tray from which the sheets to be used for printing are fed. In the following description, the tray that is determined to be the tray to be used is sometimes simply referred to as the “used tray.”

The printer 1 has multiple types of print settings as internal settings, and is capable of using different print settings according to the parameters of the received print job and the various settings configured in the printer 1. When a sheet feed tray 17 to be used is designated, the CPU 11 determines the print settings to be used for printing based on the set sheet size for the sheet feed tray 17. Concretely, if the set sheet size for the tray to be used is “A5L”, the CPU 11 will use the print settings for A5-sized sheets in landscape orientation, while if the set sheet size for the tray to be used is “A5”, the CPU 11 will use the print settings for A5-size sheets in the portrait orientation.

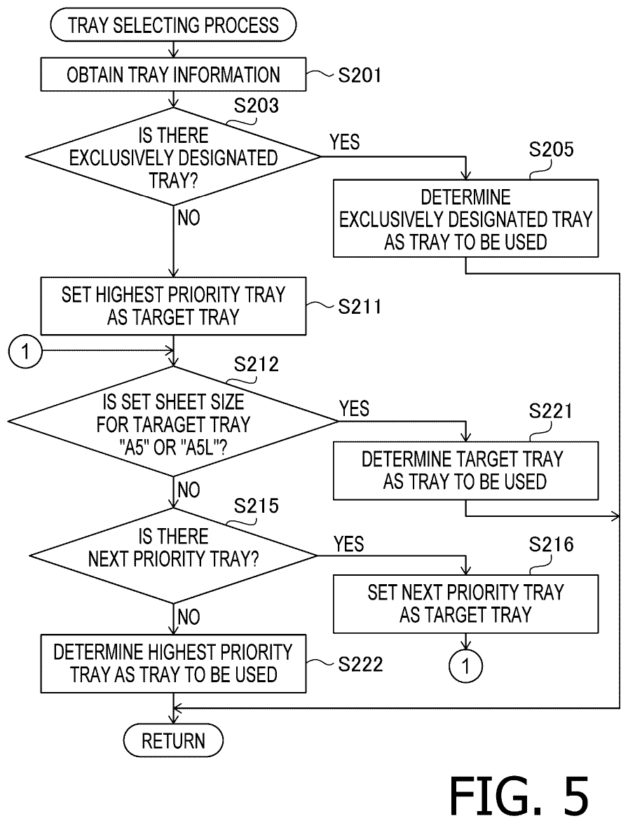

On the other hand, if the CPU 11 determines that the sheet feed tray 17 to be used has not been designated (S105: NO), the CPU 11 executes the tray selecting process (S111). The tray selecting process is a process for determining the tray to be used when an IPP job is received with a size parameter of “A5” and the sheet feed tray parameter that does not indicate a specific sheet tray. The procedures of the tray selecting process will be explained with reference to the flowchart of FIG. 5.

The CPU 11 obtains the tray information 23 (see FIGS. 3A-3C) stored in the memory 12 (S201). For example, the tray information 23 contains, for each sheet feed tray 17 installed in the printer 1, information on the set sheet size, and information on the priority, as shown in FIGS. 3A-3C.

The CPU 11 determines, in S203, whether the tray that can be used is exclusively designated or not based on the priority information contained in the tray information 23. If there is a tray of which priority is set to the exclusive designation (S203: YES), the CPU 11 determines the tray of which priority is set to the exclusive designation as the tray to be used (S205). In the example shown in FIG. 3B, the CPU 11 determines the manual feed tray 173 as the tray to be used.

In a case where the tray that can be used with the printer 1 is designated exclusively, sheets cannot be fed from trays other than the designated tray. Thus, the CPU 11 determines the exclusively designated tray as the tray to be used. In other words, even if there is a tray with the set sheet size of “A5” or “A5L” other than the exclusively designated tray, the CPU 11 will not convey the sheets from trays other than the exclusively designated tray or perform printing. Therefore, it is possible to exclusively specify the tray to be used by the printer 1 for printing operations.

When there is no tray with priority set to the exclusive designation (S203: NO), the CPU 11 identifies the sheet feed tray with the highest priority as a target tray (S211) and determines, in S212, whether or not the set sheet size of the target tray is either “A5” or “A5L.”

In the tray information 23 shown in FIG. 3A, the set sheet size for the standard tray 171, which has the highest priority, is “A4.” In such a case, the CPU 11 determines that the standard tray 171 is the target tray in S211. Since the set sheet size for the target tray is “A4” and not “A5” or “A5L,” the CPU 11 makes determination of “NO” in S212. The standard tray 171 in this case may be an example of a higher-priority tray. Even if the priority of a tray for which the set sheet size is neither “A5L” nor “A5” is higher than the priority of a tray for which the set sheet size is either “A5L” or “A5,” the CPUs will not determines to use a tray for which the set sheet size is neither “A5L” nor “A5” as the tray to be used. Therefore, printing on sheets than A5-sized sheets is avoided.

If the set sheet size of the target tray is not either “A5” or “A5L” (S212: NO), the CPU 11 checks whether there is a tray that has a next-highest priority (S215). If it is determined that there is a tray having the next-highest priority (S215: YES), the CPU 11 sets the tray with the next-highest priority as the target tray (S216) and determines whether the set sheet size of the target tray is either “A5” or “A5L” (S212). If it is determined that the set sheet size of the target tray is either “A5” or “A5L” (S212: YES), the CPU 11 determines to use the target tray as the tray to be used (S221).

For example, in the tray information 23 shown in FIG. 3A, since the set sheet size for the manual feed tray 173, which has the second highest priority, is “A5L,” the CPU 11 makes an affirmative determination of “YES” in S212 and determines to use the manual feed tray 173, which has the second highest priority, as the tray to be used. In such a case, the manual feed tray 173 may be an example of a highest-priority first tray. It should be noted that for the tray with the set sheet size “A5L,” it is highly likely that the A5-sized sheets are set in the landscape orientation.

It should be noted that even if the tray with the second priority is the expansion tray 172 with the set sheet size of “A5,” the CPU 11 makes the affirmative determination in S212 (S212: YES) and determines the expansion tray 172 with the second priority as the tray to be used. In such a case, the expansion tray 172 may be an example of a second highest-priority tray. If the priority of the tray with a set sheet size of “AS” is higher than the priority of the tray with a set sheet size of “A5L,” the CPU 11 determines the tray with the set sheet size of “A5” as the tray to be used. Therefore, even if a particular tray is not designated in the IPP job, the CPU 11 can use both the “A5L” tray and the “A5” tray.

If the set sheet size of manual feed tray 173, which has the second highest priority, is “A4,” the CPU 11 checks the set sheet size of the next-highest priority tray (i.e., the third highest priority tray). If the set sheet size of this tray is determined to be either “A5” or “A5L,” the CPU 11 selects it as the tray to be used. If an IPP job is received with a size parameter of “A5” and the sheet feed tray parameter set to automatic selection, the CPU 11 can determine the tray with a set sheet size of either “A5” or “A5L” as the tray to be used based on the priority order. In this way, it is highly likely that a tray with appropriately sized sheets will be selected for use.

On the other hand, if there is no tray with the next-highest priority, i.e., if the CPU 11 determines that the set sheet size for all the sheet feed trays 17 installed in the printer 1 is neither “A5” nor “A5L” (S215: NO), the CPU 11 determines that the sheet feed tray with the highest priority is the tray to be used (S222). For example, if the tray information 23 shown in FIG. 3C indicates that the size of all sheet feed trays 17 is “A4,” the CPU 11 determines the standard tray 171 with the highest priority as the tray to be used. In such a case, the standard tray 171 may be an example of the highest-priority tray.

If there is no tray with a set sheet size of “A5” or “A5L,” the CPU 11 determines the tray with the highest priority as the tray to be used, even if the set sheet size is neither “A5” nor “A5L.” In this way, a situation where nothing is printed because there is no tray with the appropriate size sheets set therein can be reduced.

The above configuration may be modified so that if there is no tray with a set size of “A5” or “A5L”, the printer will not print and treat it as an error, even if there is a tray with a set sheet size that is neither “A5” nor “A5L.” As shown in FIG. 3C, if the tray information 23, in which the set sheet size for all trays is “A4,” is stored, the CPU 11 may report an error instead of executing the process of S222. In such a case, each sheet feed tray 17 may be an example of a different tray. In such a configuration, if there is no tray with the appropriate size sheets set, an error will occur and nothing will be printed. Therefore, printing on sheets of sizes other than the appropriate size can be avoided.

If there is a tray that is marked with an exclusive designation in the tray information 23, and the size of the sheets set in the tray with the exclusive designation is neither “A5” nor “A5L,” the CPU 11 may choose not to print and treat the situation as an error, or the CPU 11 may choose to print on the sheets set in the tray with the exclusive designation.

After S205, S221, or S222, the CPU11 terminates the tray selecting process and returns to the IPP printing process.

In the IPP printing process shown in FIG. 4, after the tray to be used is determined in S106 or S111, the CPU 11 determines whether the set sheet size of the determined tray to be used is “A5L” or not (S121). If the CPU 11 determines that the set sheet size of the tray to be used in “A5L” (S121: YES), the CPU 11 changes the size parameter of the IPP job to “A5L” (S122). Thus, both the size parameter and the set sheet size of the tray to be used are set to “A5L.”

On the other hand, if the CPU 11 determines that the size parameter in the IPP job being received is not “A5” (S102: NO), the CPU 11 determines the tray to be used according to the priority in the tray information 23 (S131). For example, if the size parameter is “A4” and the tray information 23 is as shown in FIG. 3A or FIG. 3C, the CPU 11 determines that the standard tray 171, for which the set sheet size is “A4,” as the tray to be used. In such a case, all the sheet feed trays 17 may be examples of a third tray, and the standard tray 171 may be an example of the highest-priority third tray.

As mentioned above, the printer 1 is not configured to set sheets of sizes other than A5 in the first orientation or to perform the horizontal feed conveyance of such sheets. Therefore, if the size parameter in the IPP job is not “A5,” the CPU 11 can avoid unnecessary processing by skipping the determination of the orientation of the sheets.

After S122 or S131, or if the CPU 11 determines that the size parameter is “A5” and the set sheet size of the tray to be used is not “A5L” (S121: NO), the CPU 11 executes the driver-based printing process (S141). It should be noted that the CPU 11 may treat the situation as an error if the size parameter in the IPP job is not a printable size or if there is no tray to which a sheet size that matches the size parameter is set.

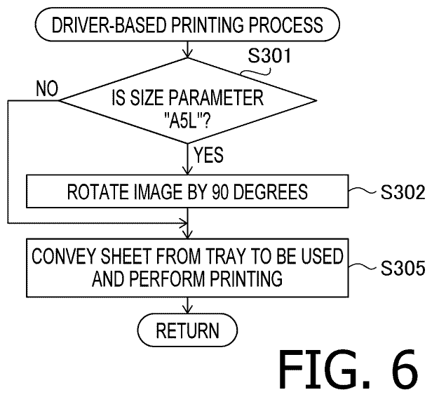

The driver-based printing process is described with reference to the flowchart shown in FIG. 6. The driver-based printing process is a process in which, with the tray to be used having been determined, a sheet is conveyed from the tray and printing is performed on the conveyed sheet by the printing engine 15.

The driver-based printing process is a process of printing driver jobs. If the CPU 11 determines that the print job received by the printer 1 from an external device is a driver job output by the printer driver 41, the CPU 11 executes the driver-based printing process based on the driver printing program 22 (see FIG. 1). As mentioned above, when generating a print job, the printer driver 41 can accept either designation of “A5” or “A5L” as the size parameter. When the CPU 11 receives a driver job, the CPU 11 determines the tray to be used and the print settings to be used based on the size parameter and the tray information 23. That is, if “A5L” is set as the size parameter while the sheet feed tray 17 to be used is not designated, for example, the printer 1 can use the tray with the set sheet size being “A5L” as the tray to be used and perform printing based on an image rotated by 90 degrees.

When executing the driver-based printing process based on the driver printing program 22 in S141 of the IPP printing process, the CPU 11 converts the size parameter of the IPP job, the tray to be used, and the various parameters contained in the IPP job into information in a format used by the driver-based printing process. The CPU 11 then executes the driver-based printing process for the IPP job that contains the converted parameters. As mentioned above, in the present specification, the image data that indicates the image to be printed contained in the printing job is assumed to be image data that indicates an image in the portrait orientation.

In the driver-based printing process, the CPU 11 determines whether the size parameter indicates “A5L” or not (S301). When the CPU 11 determines that the size parameter is “A5L” (S301: YES), the CPU 11 rotates the image represented by the image data subject to printing by 90 degrees. As a result, the image data, which originally represents an image in a portrait orientation (where the height is longer than the width), is converted into image data that represents the image in a landscape orientation (where the width is longer than the height) (S302). As a result, the image data that represents the image to be printed becomes image data that represents a landscape image. Further, the CPU 11 determines that the current printing will be performed using the print setting for landscape A5 size printing.

After S302, if it is determined that the size parameter is not “A5L” (S301: NO), the CPU 11 conveys the sheet from the determined tray to be used and print the image to be printed on the conveyed sheet (S305). After S305, the CPU 11 terminates the driver-based printing process, returns to the IPP printing process, and terminates the IPP printing process.

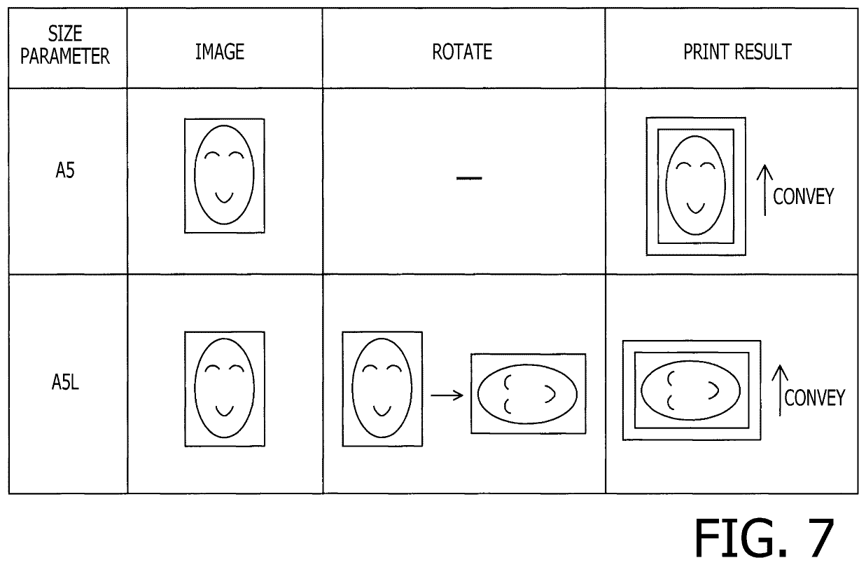

As shown in FIG. 7, if the size parameter is “A5,” the printer 1 conveys the A5 size sheet set in the tray in the vertical state, where the short sides of the sheet are positioned at the leading and trailing edges in the conveying direction, and prints with using the print settings for the A5 size printing in the portrait orientation. When performing printing using the print setting for an A5 size sheet in the portrait orientation, the printer 1 prints the image in the portrait orientation without rotating the image, onto a sheet that is conveyed without being rotated.

As shown in FIG. 7, if the size parameter is “A5L,” the printer 1 conveys the A5 size sheet set in the tray in the landscape orientation, where the long sides of the sheet are positioned at the leading and trailing edges in the conveying direction, and prints using the print settings for A5 size printing in the landscape orientation. When performing printing using the print setting for an A5 size sheet in the landscape orientation, the printer 1 rotates the image in the portrait orientation by 90 degrees and prints it as a landscape image onto the sheet conveyed in the landscape orientation.

In the IPP printing process, if the size parameter is “A5” and no sheet feed tray is designated, the CPU 11 determines the tray with the highest priority that has a setting size of either “A5” or “A5L” as the tray to be used, based on the priority. In addition, since the CPU 11 changes the size parameter to match the set sheet size of the determined tray, the CPU 11 can select the print settings to be used and decide whether or not to rotate the image, in the same way as in the driver-based printing process. Therefore, even if a particular sheet tray is not designated as a parameter for the sheet feed tray in the IPP client application 31, it becomes possible to perform printing equivalent to printing on an A5 size sheet in the landscape orientation in a driver job.

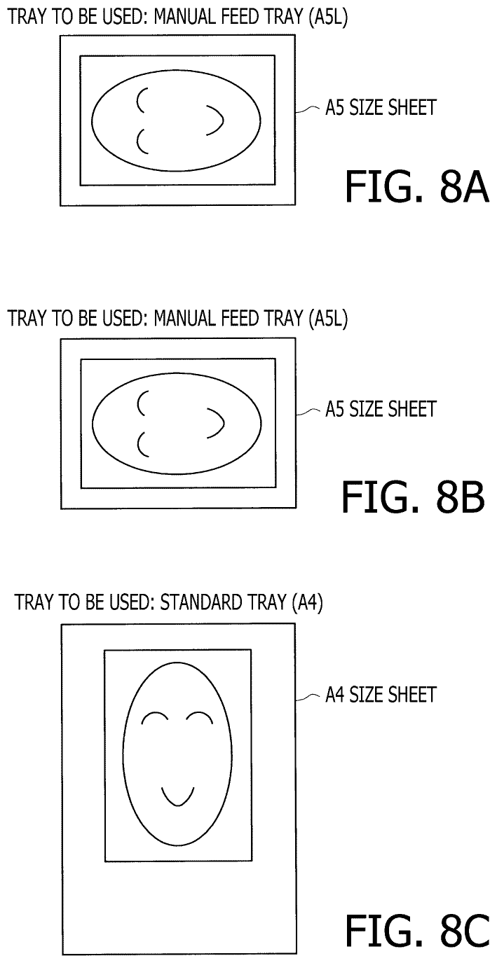

When an IPP job is received with the size parameter set to “A5” and the sheet feed tray to be used is not designated in a state where the tray information 23 shown in FIGS. 3A to 3C is stored, the print result on the printer 1 will be as shown in FIGS. 8A to 8C, respectively.

If the tray information 23 is as shown in FIG. 3A, the printer 1 determines that the manual feed tray 173, which has the highest priority with a setting size of either “A5” or “A5L,” will be used as the tray to be used. Furthermore, since the setting size of the manual feed tray 173 is “A5L,” the printer 1 changes the size parameter to “A5L.” Consequently, the printer 1 feeds the A5 size sheet in the landscape orientation from the manual feed tray 173 and prints using the print settings for A5 size printing in the landscape orientation. As a result, as shown in FIG. 8A, a printed document is output with a landscape-oriented image printed on an A5 size sheet in the landscape orientation.

If the tray information 23 is as shown in FIG. 3B, the printer 1 determines the manual feed tray 173, which has an exclusive designation, as the sheet feed tray. Furthermore, since the setting size of the manual feed tray 173 is “A5L,” the printer 1 changes the size parameter to “A5L.” Consequently, the printer 1 feeds the A5 size sheet in the landscape orientation from the manual feed tray 173 and prints using the print settings for A5 size printing in the landscape orientation. As a result, as shown in FIG. 8B, a printed document is output with a landscape-oriented image printed on an A5 size sheet in the landscape orientation.

If the tray information 23 is as shown in FIG. 3C, since there is no tray with a setting size of “A5” or “A5L,” the printer 1 determines the standard tray 171, which has the highest priority, as the sheet feed tray. Consequently, the printer 1 feeds an A4 size sheet in the portrait orientation from the standard tray 171 and prints using the print settings for A5 size printing in the portrait orientation. As a result, as shown in FIG. 8C, a printed document is output with an A5 size image in portrait orientation printed on an A4 size sheet in portrait orientation.

In FIG. 8C, the example shows the print position when printing an A5 size image on an A4 size sheet, with the image printed at the horizontal center and near the top in the vertical direction. However, the print position is not limited to this. For example, the printer 1 may print the image aligned to the left or right in the horizontal direction, or aligned to the center or bottom in the vertical direction.

As explained in detail above, the printer 1 of this embodiment can perform printing using the sheet feed in the landscape orientation for A5 size sheets and the print settings for A5 size printing in the landscape orientation when the size parameter “A5L” is set in the driver job generated by the printer driver 41. Furthermore, when the printer 1 receives an IPP job in which the size parameter is set to “A5” and no sheet feed tray is designated, it can start the horizontal feed conveyance of an A5 size sheet set in the first orientation corresponding to horizontal feed conveyance and execute printing using the print settings for A5 size printing in the landscape orientation. As a result, the printer 1 can perform printing equivalent to that of a driver job where “A5L,” a size parameter not defined in the IPP standard, is set.

It should be noted that this embodiment is merely an example and does not limit the present invention in any way. Therefore, various modifications and alterations can be made within the scope of the essence of the present invention. For example, the printer 1 is not limited to a dedicated printing device and may also be a multifunction device, copier, or fax machine. Additionally, the printing method of the printer 1 may be a thermal transfer method, a thermal printing method, or other methods.

In the embodiment, the printer 1 is shown with a configuration having three sheet feed trays 17, but the number of sheet feed trays 17 is not limited to this. Additionally, in the embodiment, it is described that the printer 1 has multiple sheet feed trays 17 capable of accommodating A5 size sheets in two orientations. However, there may also be trays dedicated to only the first orientation or only the second orientation. For example, there may be a tray that can only accommodate A5 size sheets in the first orientation.

In addition, the set position for A5 size sheets in a tray capable of accommodating A4 size sheets in the printer 1 is not limited to the example shown in FIG. 2. For instance, when setting A5 size sheets in the first orientation, they may be placed toward the rear of the tray. Likewise, when setting A5 size sheets in the second orientation, the sheets may be aligned to the left or right side in the horizontal direction of the tray, or they may also be placed toward the rear of the tray.

In the embodiment, as shown in FIG. 3B, an example is provided where the exclusive designation is restricted to a single tray; however, the printer 1 may also accept an exclusive designation that designates the use of multiple trays among the sheet feed trays 17. When the exclusive designation applies to multiple trays, after the CPU 11 determines “YES” in S203 of FIG. 5, it proceeds to execute steps S211 to S222, treating the multiple designated trays as candidates for selection. As a result, the CPU 11 can determine one of the designated trays as the sheet feed tray to be used.

The printer 1 may also include a program and data for realizing an embedded web server function (hereinafter referred to as “EWS”). In such a case, the printer 1 can accept the configuration of settings such as the tray size and priority for the sheet feed trays 17 through the EWS.

In the embodiment, it was assumed that the only sheet size that can be set in the first orientation is A5 size, but this is not limited to A5. For example, the printer 1 may include a sheet tray capable of setting A4 size or letter size sheets in the first orientation. In this case, A4 size and letter size are examples of particular sizes, and a sheet tray capable of setting A4 or letter size sheets in the first orientation is an example of a tray supporting a horizontal feed conveyance. Additionally, the sheet tray capable of setting A4 or letter size sheets in the first orientation may also support setting A4 or letter size sheets in the second orientation. A sheet tray capable of setting A4 or letter size sheets in the second orientation may be an example of a tray that supports a vertical feed conveyance.

In any flowchart disclosed in the embodiment, the execution order of multiple processes in any of the steps can be freely changed or executed in parallel, as long as no contradictions arise in the process content.

The processes disclosed in the embodiment may be executed by a single CPU, multiple CPUs, hardware such as ASICs, or a combination of these. Additionally, the processes disclosed in the embodiment can be realized in various forms, such as a recording medium that stores a program for executing the processes, or other methods.

What is claimed is:

1. A printer, comprising,
a sheet tray configured to accommodate a sheet of an A5 size in a first orientation, the first orientation corresponding to a horizontal feed conveyance in which long sides of the sheet of the A5 size are positioned at leading and trailing ends in a conveying direction; and
a controller,
wherein the controller is configured to receive a print job from an IPP client configured to generate the print job in accordance with an IPP standard, and perform printing based on the received print job, and
wherein, in a case where the A5 size is set as a sheet size and a particular sheet tray is not designated as a sheet feed tray in the print job received from the IPP client, the controller is configured to:
start the horizontal feed conveyance of the sheet of the A5 size set in the sheet tray in the first orientation; and
perform printing, based on the print job, on the sheet conveyed from the sheet tray with using print setting for a landscape A5 size printing.

2. The printer according to claim 1,
wherein the controller is configured to set a sheet size for the sheet tray attached to the printer, a settable sheet size including a first size for a landscape A5 size printing and a second size for a portrait A5 size printing, and
wherein, in a case where the A5 size is set as the sheet size and a particular sheet tray is not designated as the sheet feed tray in the print job received from the IPP client, the controller is configured to:
start the horizontal feed conveyance of the sheet of the A5 size set in a first tray in the first orientation, the first tray being the sheet tray for which the first size is set; and
perform printing, based on the print job, on the sheet conveyed from the first tray with using the print setting for the landscape A5 size printing.

3. The printer according to claim 2,
wherein, in a case where the A5 size is set as the sheet size and a particular sheet tray is not designated as the sheet feed tray in the print job received from the IPP client and in a case where the first tray is not attached to the printer and a second tray is attached to the printer, the second tray being the sheet tray for which the second size is set, the controller is configured to:
start a vertical feed conveyance of the sheet of the A5 size set in the second tray in a second orientation, the second orientation corresponding to the vertical feed conveyance in which short sides of the sheet of the A5 size are positioned at leading and trailing ends in the conveying direction; and
perform printing, based on the print job, on the sheet conveyed from the second tray with using the print setting for the portrait A5 size printing.

4. The printer according to claim 2,
wherein a plurality of sheet trays are attachable to the printer,
wherein the controller is configured to set priority orders to the plurality of sheet trays, respectively,
wherein, in a case where the A5 size is set as the sheet size and a particular sheet tray is not designated as the sheet feed tray in the print job received from the IPP client, the controller is configured to:
start the horizontal feed conveyance of the sheet of the A5 size set in a first highest-priority tray in the first orientation, the first highest-priority tray having a highest-priority order among the plurality of sheet trays; and
perform printing, based on the print job, on the sheet conveyed from the first highest-priority tray with using the print setting for the landscape A5 size printing.

5. The printer according to claim 4,
wherein, in a case where the A5 size is set as the sheet size and a particular sheet tray is not designated as the sheet feed tray in the print job received from the IPP client, and:
in a case where the second tray having a priority order higher than a priority order of the first highest-priority tray is not attached to the printer, the second tray being the sheet tray for which the second size is set, the controller is configured to:
start the horizontal feed conveyance of the sheet of the A5 size set in a first highest-priority tray in the first orientation, the first highest-priority tray having a highest-priority order among the plurality of sheet trays; and
perform printing, based on the print job, on the sheet conveyed from the first highest-priority tray with using the print setting for the landscape A5 size printing; and
in a case where the second tray having the priority order higher than the priority order of the first highest-priority tray is attached to the printer, the controller is configured to:
start a vertical feed conveyance of the sheet of the A5 size set in a second highest-priority tray in a second orientation, the second highest-priority tray being a sheet tray having a highest priority order among the second tray, the second orientation corresponding to a portrait feed conveyance in which short sides of the sheet of the A5 size are positioned at leading and trailing ends in the conveying direction; and
perform printing, based on the print job, on the sheet conveyed from the second highest-priority tray with using the print setting for the portrait A5 size printing.

6. The printer according to claim 5,
wherein, in a case where the A5 size is set as the sheet size and a particular sheet tray is not designated as the sheet feed tray in the print job received from the IPP client, and:
in a case where the second tray having the priority order higher than the priority order of the first highest-priority tray is not attached to the printer, the controller is configured to:
start the horizontal feed conveyance of the sheet of the A5 size set in the first highest-priority tray in the first orientation; and
perform printing, based on the print job, on the sheet conveyed from the first highest-priority tray with using the print setting for the landscape A5 size printing; and
in a case where the second tray having the priority order higher than the priority order of the first highest-priority tray is attached to the printer, the controller is configured to:
start the vertical feed conveyance of the sheet of the A5 size set in the second highest-priority tray in the second orientation; and
perform printing, based on the print job, on the sheet conveyed from the second highest-priority tray with using the print setting for the portrait A5 size printing, and
wherein, even if a higher-priority tray is attached to the printer, the higher-priority tray having a priority order higher than priority orders of the first highest-priority tray and the second highest-priority tray, the higher-priority tray being the sheet tray for which neither the first size nor the second size is set, the controller is not configured to start conveyance from the higher-priority tray.

7. The printer according to claim 5,
wherein, in a case where the A5 size is set as the sheet size and a particular sheet tray is not designated as the sheet feed tray in the print job received from the IPP client, and:
in a case where the second tray having the priority order higher than the priority order of the first highest-priority tray is not attached to the printer, the controller is configured to:
start the horizontal feed conveyance of the sheet of the A5 size set in the first highest-priority tray in the first orientation; and
perform printing, based on the print job, on the sheet conveyed from the first highest-priority tray with using the print setting for the landscape A5 size printing;
in a case where the second tray having the priority order higher than the priority order of the first highest-priority tray is attached to the printer, the controller is configured to:
start the vertical feed conveyance of the sheet of the A5 size set in the second highest-priority tray in the second orientation; and
perform printing, based on the print job, on the sheet conveyed from the second highest-priority tray with using the print setting for the portrait A5 size printing; and
in a case where neither the first tray nor second tray is attached to the printer, the controller is configured to:
start conveyance of the sheet of the A5 size set in a highest-priority tray having a highest-priority order among sheet trays for which neither the first size nor the second size is set; and
perform printing, based on the print job, on the sheet conveyed from the highest-priority tray with using the print setting for the portrait A5 size printing.

8. The printer according to claim 5,
wherein, in a case where the A5 size is set as the sheet size and a particular sheet tray is not designated as the sheet feed tray in the print job received from the IPP client, and:
in a case where the second tray having the priority order higher than the priority order of the first highest-priority tray is not attached to the printer, the controller is configured to:
start the horizontal feed conveyance of the sheet of the A5 size set in the first highest-priority tray in the first orientation; and
perform printing, based on the print job, on the sheet conveyed from the first highest-priority tray with using the print setting for the landscape A5 size printing;
in a case where the second tray having the priority order higher than the priority order of the first highest-priority tray is attached to the printer, the controller is configured to:
start the vertical feed conveyance of the sheet of the A5 size set in the second highest-priority tray in the second orientation; and
perform printing, based on the print job, on the sheet conveyed from the second highest-priority tray with using the print setting for the portrait A5 size printing; and
in a case where neither the first tray nor second tray is attached to the printer, and an other tray is attached to the printer, the other tray being the sheet tray for which neither the first size nor the second size is set, the controller is not configured to start conveyance from the other tray.

9. The printer according to claim 5,
wherein, in a case where the A5 size is set as the sheet size and a particular sheet tray is not designated as the sheet feed tray in the print job received from the IPP client, and:
in a case where the second tray having the priority order higher than the priority order of the first highest-priority tray is not attached to the printer, the controller is configured to:
start the horizontal feed conveyance of the sheet of the A5 size set in the first highest-priority tray in the first orientation; and
perform printing, based on the print job, on the sheet conveyed from the first highest-priority tray with using the print setting for the landscape A5 size printing; and
in a case where the second tray having the priority order higher than the priority order of the first highest-priority tray is attached to the printer, the controller is configured to:
start the vertical feed conveyance of the sheet of the A5 size set in the second highest-priority tray in the second orientation; and
perform printing, based on the print job, on the sheet conveyed from the second highest-priority tray with using the print setting for the portrait A5 size printing, and
wherein, in a case where an A4 size is set as the sheet size and a particular sheet tray is not designated as the sheet feed tray in the print job received from the IPP client, the controller is configured to:
start a vertical feed conveyance of the sheet of the A4 size set in a third highest-priority tray, the third highest-priority tray being a sheet tray having a highest priority order among a third tray, the third tray being a sheet tray for which a third size for a portrait A4 size printing is set; and
perform printing, based on the print job, on the sheet conveyed from the third highest-priority tray with using the print setting for the portrait A4 size printing.

10. The printer according to claim 9,
wherein the settable sheet size for the sheet tray attached to the printer includes the third size and does not include a fourth size for a landscape A4 size printing.

11. The printer according to claim 4,
wherein, in a case where the A5 size is set as the sheet size and a particular sheet tray is designated as the sheet feed tray in the print job received from the IPP client, and:
in a case where the first size is set for the particular sheet tray, the controller is configured to:
start the horizontal feed conveyance of the sheet of the A5 size set in the particular sheet tray in the first orientation; and
perform printing, based on the print job, on the sheet conveyed from the particular sheet tray with using the print setting for the landscape A5 size printing; and
in a case where the second size is set for the particular sheet tray, the controller is configured to:
start a vertical feed conveyance of the sheet of the A5 size set in the particular sheet tray in a second orientation, the second orientation corresponding to the vertical feed conveyance in which short sides of the sheet of the A5 size are positioned at leading and trailing ends in the conveying direction; and
perform printing, based on the print job, on the sheet conveyed from the particular sheet tray with using the print setting for the portrait A5 size printing.

12. The printer according to claim 4,
wherein, in a case where the A5 size is set as the sheet size and automatic selection of the sheet feed tray is set in the print job received from the IPP client, and in a case where the first size is set for the particular sheet tray, the controller is configured to:
start the horizontal feed conveyance of the sheet of the A5 size set in the first highest-priority tray in the first orientation; and
perform printing, based on the print job, on the sheet conveyed from the first highest-priority tray with using the print setting for the landscape A5 size printing.

13. The printer according to claim 4,
wherein a plurality of sheet trays including the first tray are attachable to the printer,
wherein the controller is configured to exclusively designate one of sheet trays attached to the printer,
wherein, in a case where the A5 size is set as the sheet size and a particular sheet tray is not designated as the sheet feed tray in the print job received from the IPP client, the one of sheet trays is not exclusively designated, and:
in a case where the second tray having the priority order higher than the priority order of the first highest-priority tray is not attached to the printer, the second tray being the sheet tray for which the second size is set, the controller is configured to:
start the vertical feed conveyance of the sheet of the A5 size set in the first highest-priority tray in the first orientation; and
perform printing, based on the print job, on the sheet conveyed from the first highest-priority tray with using the print setting for the landscape A5 size printing; and
in a case where the second tray having the priority order higher than the priority order of the first highest-priority tray is attached to the printer, the controller is configured to:
start a vertical feed conveyance of the sheet of the A5 size set in a second highest-priority tray in a second orientation, the second highest-priority tray being a sheet tray having a highest priority order among the second tray, the second orientation corresponding to the vertical feed conveyance in which short sides of the sheet of the A5 size are positioned at leading and trailing ends in the conveying direction; and
perform printing, based on the print job, on the sheet conveyed from the second highest-priority tray with using the print setting for the portrait A5 size printing, and
wherein, in a case where the A5 size is set as the sheet size and a particular sheet tray is not designated as the sheet feed tray in the print job received from the IPP client, the one of sheet trays is exclusively designated, and:
in a case where the first size is set for the one of sheet trays, the controller is configured to:
start the horizontal feed conveyance of the sheet of the A5 size set in the one of sheet trays in the first orientation; and
perform printing, based on the print job, on the sheet conveyed from the one of sheet trays with using the print setting for the landscape A5 size printing;
in a case where the second size is set for the one of sheet trays, the controller is configured to:
start the vertical feed conveyance of the sheet of the A5 size set in the one of sheet trays in the second orientation; and
perform printing, based on the print job, on the sheet conveyed from the one of sheet trays with using the print setting for the portrait A5 size printing; and
in a case where the first tray or the second tray is attached to the printer in addition to the one of sheet trays, the controller is configured to:
not start sheet conveyance from the first tray or the second tray attached to the printer; and
not perform printing with using the print setting for the landscape A5 size printing or the print setting for the portrait A5 size printing.

14. The printer according to claim 1,
wherein the controller is configured to perform printing based on a print job received from a printer driver; and
wherein, in a case where an A5 size sheet in a landscape orientation for a landscape A5 size printing is set as the sheet size in the print job received from the printer driver, the controller is configured to:
start the horizontal feed conveyance of the sheet of the A5 size set in the sheet tray in the first orientation; and
perform printing, based on the print job, on the sheet conveyed from the sheet tray with using the print setting for the landscape A5 size printing,
wherein, in a case where an A5 size sheet in a portrait orientation for a portrait A5 size printing is set as the sheet size in the print job received from the printer driver, the controller is configured to:
start a vertical feed conveyance of the sheet of the A5 size set in the sheet tray in a second orientation, the second orientation corresponding to the vertical feed conveyance in which short sides of the sheet of the A5 size are positioned at leading and trailing ends in the conveying direction; and
perform printing, based on the print job, on the sheet conveyed from the sheet tray with using the print setting for the portrait A5 size printing,
wherein, in a case where the A5 size is set as the sheet size and a particular sheet tray is not designated as the sheet feed tray in the print job received from the IPP client, the controller is configured to:
start the horizontal feed conveyance of the sheet of the A5 size set in the sheet tray in the first orientation; and
perform printing, based on the print job, on the sheet conveyed from the sheet tray with using the print setting for the landscape A5 size printing, the print setting for the landscape A5 size printing being setting used in a case where the A5 size sheet in the landscape orientation is set as the sheet size in the print job received from the printer driver.

15. A printer, comprising,
a tray supporting horizontal feeding which is a sheet tray configured to accommodate a sheet of a particular size in a first orientation, the first orientation corresponding to a horizontal feed conveyance in which long sides of the sheet of the A5 size are positioned at leading and trailing ends in a conveying direction; and
a controller,
wherein the controller is configured to receive a print job from an IPP client configured to generate the print job in accordance with an IPP standard, and perform printing based on the received print job, and
wherein, in a case where the particular size is set as a sheet size and a particular sheet tray is not designated as a sheet feed tray in the print job received from the IPP client, the controller is configured to:
start the horizontal feed conveyance of the sheet of the particular size set in the tray supporting horizontal feeding in the first orientation; and
perform printing, based on the print job, on the sheet conveyed from the tray supporting horizontal feeding with using print setting for a landscape printing of a sheet of the particular size.
